(19) United States
(12) Patent Application Publication
(10) Pub. No.: US 2007/0233658 A1
(43) Pub. Date: Oct. 4, 2007

(54) IDENTIFYING A RESULT RESPONSIVE TO LOCATION DATA FOR MULTIPLE USERS

(75) Inventors: Stephen J. Coughlin, Falls Church, VA (US); Adrienne C. Meisels, New York, NY (US)

Correspondence Address: FISH & RICHARDSON P.C., P.O. BOX 1022, MINNEAPOLIS, MN, 55440-1022, US

(73) Assignee: AOL LLC, Dulles, VA (US)

(21) Appl. No.: 11/534,443

(22) Filed: Sep. 22, 2006

Related U.S. Application Data
(60) Provisional application No. 60/789,910, filed on Apr. 7, 2006.
(60) Provisional application No. 60/787,690, filed on Mar. 31, 2006.
(60) Provisional application No. 60/747,746, filed on May 19, 2006.

(51) Int. Cl. G06F 17/30

(52) U.S. Cl. 707/3

(57) ABSTRACT

According to one general aspect, a method for searching includes receiving, at a host from a client device, a search query that enables access to location data associated with multiple users. Receiving the search query includes receiving a travel objective and receiving an indication of a particular place. The method also includes accessing the location data associated with the multiple users and referencing the travel objective that relates to the location data associated with the multiple users. The method also includes identifying a result associated with the particular place, and enabling the client device to access the result. The result is responsive to the search query and the travel objective

### CROSS REFERENCE TO RELATED APPLICATIONS

The present application claims priority from U.S. Provisional Application No. 60/789,910, filed Apr. 7, 2006, U.S. Provisional Application No. 60/787,690, filed Mar. 31, 2006, and U.S. Provisional Application No. 60/747,746, filed May 19, 2006. The contents of the prior applications are incorporated herein in their entirety by reference.

### TECHNICAL FIELD

This document relates to identifying a result responsive to location data for multiple users.

### BACKGROUND

A user may wish to find a particular place (e.g., a restaurant or a movie theater). To do so the user may turn to the Internet for assistance. Specifically, the user may use one or more online search engines or search sites to find the particular place. For example, the user searching for a restaurant may access an online search engine operated at www.washingtonian.com. The user submits a search query to the search engine. The search query may specify the type of cuisine and the price range the user is interested in. The search engine then locates a restaurant that satisfies the user's specified criteria.

Similar to the above scenario, multiple users may wish to find a particular place (e.g., a restaurant or a movie theater) to meet each other. To do so, one or both of the multiple users may turn to the Internet to identify universe of destinations satisfying their general constraints (e.g., type of restaurant or a particular movie), from which they make a manual selection.

### SUMMARY

According to one general aspect, a method for searching includes receiving, at a host from a client device, a search query that enables access to location data associated with multiple users. Receiving the search query includes receiving a travel objective and receiving an indication of a particular place. The method also includes accessing the location data associated with the multiple users and referencing the travel objective that relates to the location data associated with the multiple users. The method also includes identifying a result associated with the particular place, and enabling the client device to access the result. The result is responsive to the search query and the travel objective

Implementations of the above general aspect may include one or more of the following features. For example, referencing the travel objective may include determining that differences in a travel commitment for the multiple users at multiple locations should be minimized. Alternatively or additionally, referencing the travel objective includes minimizing the travel commitment associated with each of the multiple users at multiple locations and minimizing the differences in the travel commitment associated with each of the multiple users at the multiple locations. The travel commitment may include travel time or a travel distance.

Receiving the search query may include receiving a first location related to a first of the multiple users and receiving a second location related to a second of the multiple users. The first location may include a present location of the client device, and the second location may include a location for a device other than the client device. The method for searching also may include identifying a result location based on the first location and the second location. Alternatively or additionally, receiving the search query may include receiving a first location related to a first user, receiving a second location related to a second user, and receiving the travel objective for minimizing differences in a travel commitment for the first user and the second user. Alternatively or additionally, receiving the search query may include receiving an instruction specifying a manner in which directions should be communicated to a first user and a second user. Identifying the result may include identifying a destination that is responsive to the search query.

Receiving the search query may further include receiving an instruction specifying a modality of travel of the first of the multiple users and the second of the multiple users and providing directions to a result location for the first of the multiple users and the second of the multiple users based on the modality of travel of the first of the multiple users and the second of the multiple users. Receiving the instruction specifying the modality of travel may include receiving the instruction from the client device. Alternatively or additionally, receiving the instruction specifying the modality of travel may include receiving a first set of instruction from the first of the multiple users, specifying the modality of travel of the first of the multiple users, and receiving a second set of instruction from the second of the multiple users, specifying the modality of travel of the second of the multiple users.

The search query received from the client device may specify an online identity. The method for searching also may include determining a location by referencing the online identity. Referencing the online identity may include accessing a presence-based service configured to indicate whether the online identity is registered. Accessing the presence-based service may include accessing an instant messaging service. Determining the location by referencing the online identity may include determining the location associated with the online identity. Determining the location associated with the online identity may include determining the location based on location information displayed with the online identity on the presence-based service. Determining the location associated with the online identity may include accessing a user profile including location information for the online identity.

Identifying the result may include accessing current road conditions information and identifying the result based on the current road conditions information. The method for searching also may include sending a first set of directions to a result location to a first user at the client device and sending a second set of directions to the result location to a second user at a device other than the client device. The directions may include turn-by-turn voice guided navigations, text directions, mapping directions, walking directions, or public transportation directions. Sending the first set of directions may include accessing a first location related to the first user and generating the directions to the result location from the first location. Sending the second set of directions may include accessing a second location related to the second user and generating the directions to the result location from the second location.

Enabling the client device to access the result may include displaying one or more results to a first user at the client device, receiving, from the first user, an instruction to provide the first user and a second user with directions to the one or more results, and providing the directions to the one or more results according to the instruction. The one or more results are responsive to the search query and the travel objective.

Alternatively or additionally, enabling the client device to access the result may include displaying one or more results to a firs user at the client device, receiving, from the first user, a first set of instructions associated with providing the first user with directions to the one or more results, providing the first user with directions to the one or more results according to the first set of instructions, displaying the one or more results to a second user, receiving, from the second user, a second set of instructions associated with providing the second user with directions to the one or more results, and providing the second user with the directions to the one or more results according to the second set of instructions. The one or more results are responsive to the search query and the travel objective

The method for searching also may include receiving an instruction at the host, specifying a type of directions that should be provided to a result location for a first user and a second user.

According to another general aspect, a method for searching includes receiving, at a host from a client device, a search query that enables access to location data associated with each of multiple users. Receiving the search query includes receiving a travel objective and receiving an indication of a particular place. The method also includes accessing the location data associated with each of the multiple users, referencing the travel objective that relates to the location data associated with each of the multiple users, and identifying at least one result associated with the particular place. The at least one result is responsive to the search query and the travel objective. The method also includes displaying the at least one result to a user of the client device, enabling the user to select the at least one result, and providing directions to the at least one result upon the user selecting the at least one result.

Implementations of the above general aspect may include one or more of the following features. For example, receiving the search query may include receiving a first location related to a first of the multiple users and receiving a second location related to a second of the multiple users. Alternatively or additionally, receiving the search query may include receiving a first location related to a first of the multiple users and receiving an instruction to obtain a second location related to a second of the multiple users. Receiving the instruction to obtain the second location may include instructing the host to contact a server to obtain the second location. Additionally, receiving the search query may include receiving an instruction specifying a type of directions that should be provided to a result location for a first of the multiple users and a second of the multiple users.

Alternatively or additionally, receiving the search query may include receiving an instruction specifying a manner in which the directions to a result location should be communicated to a first of the multiple users and a second of the multiple users.

Referencing the travel objective may include determining that differences in a travel commitment for the multiple users at multiple locations should be minimized. The travel commitment may include travel time or a travel distance.

According to another general aspect, a system for searching includes a processing device and a memory storing executable instructions for causing the processing device to receive, at a host from a client device, a search query that enables access to location data for each of multiple users. The search query includes a travel objective and an indication of a particular place. The memory also includes instructions for causing the processor device to access the location data for each of the multiple users, to reference the travel objective that relates to the location data for each of the multiple users, to identify a result associated with the particular place, and to enable the client device to access the result. The result is responsive to the search query and the travel objective.

Implementations of the above general aspect may include one or more of the following features. For example, the instructions may cause the processing device to reference the travel objective to determine that differences in a travel commitment for the multiple users at multiple locations is minimized. The travel commitment may include travel time or a travel distance. The instructions may cause the processing device to access the location data for each of the multiple users from the search query. The instructions may cause the processing device to receive an instruction, from the client device via the search query, and, in response to the instruction, to obtain the location data for the multiples users from a server containing the location data for the multiple users. The server may be operated by a telephone service provider with which the multiple users are registered. The instructions may cause the processing device to send a first set of directions to a result location to a first of the multiple users at the client device and to send a second set of directions to the result location to a second of the multiple users at a device other than the client device.

### DESCRIPTION OF DRAWINGS

FIGS. 1-4 illustrate exemplary user interfaces that may be presented to a user searching for a particular place.

FIG. 5 illustrates an exemplary user interface displaying results responsive to a search query and a travel objective.

FIG. 6 illustrates an exemplary user interface for providing directions/mapping information.

FIG. 7 is a block diagram of a communication system capable of providing a client device with a result responsive to a search query and a travel objective.

FIG. 8 is a flow chart of an exemplary process by which a host provides a client device with a result responsive to a search query and a travel objective.

FIGS. 9-10 illustrate exemplary techniques a host may use to find a result location associated with a result that is responsive to a search query and a travel objective.

### DETAILED DESCRIPTION

A host is configured to identify results responsive to a search query and a travel objective. The search query may be provided by a user of a client device, and the search query may enable access to location data for multiple users at multiple locations. The location data may include a location of a first user as a first of the multiple locations and a location of a second user as a second of the multiple locations. The travel objective may include a user-selectable option to which the results should be responsive. For example, the travel objective includes a user-selectable option for minimizing a travel commitment to a result location for each of the multiple users and also minimizing differences in the travel commitment to the result location for the multiple users. Alternatively, the travel objective includes a user-selectable option for identifying a result that minimizes total travel commitment among the multiple users at the multiple locations. In still another alternative, the travel objective includes a user-selectable option for identifying a result that minimizes the travel commitment for just one of the multiple users at the multiple locations. The travel commitment may include a travel distance and/or travel time.

In one example, the user of the client device may search for a particular place such as a restaurant, where the user wishes to have dinner with others. The user accesses a host and submits a search query to the host. The search query may include one or more criteria for the restaurant. For example, the search query may include a type of cuisine, a price range, and a particular rating. The search query may enable access to location data for each of the multiple users. For example, the search query may provide the location data for the user and some or all of multiple other identities, corresponding to the people with whom the user wishes to dine at the restaurant. Alternatively or additionally, the search query may instruct the host to obtain the location data for some or all of the multiple other identities. In response, the host may contact a server to obtain the location data for some or all of the multiple other identities. For example, the host may contact the server operated by a telephone service provider (e.g., Verizon or Sprint) with which the multiple users are registered, and the host may obtain from the server the location data for the multiple other identities.

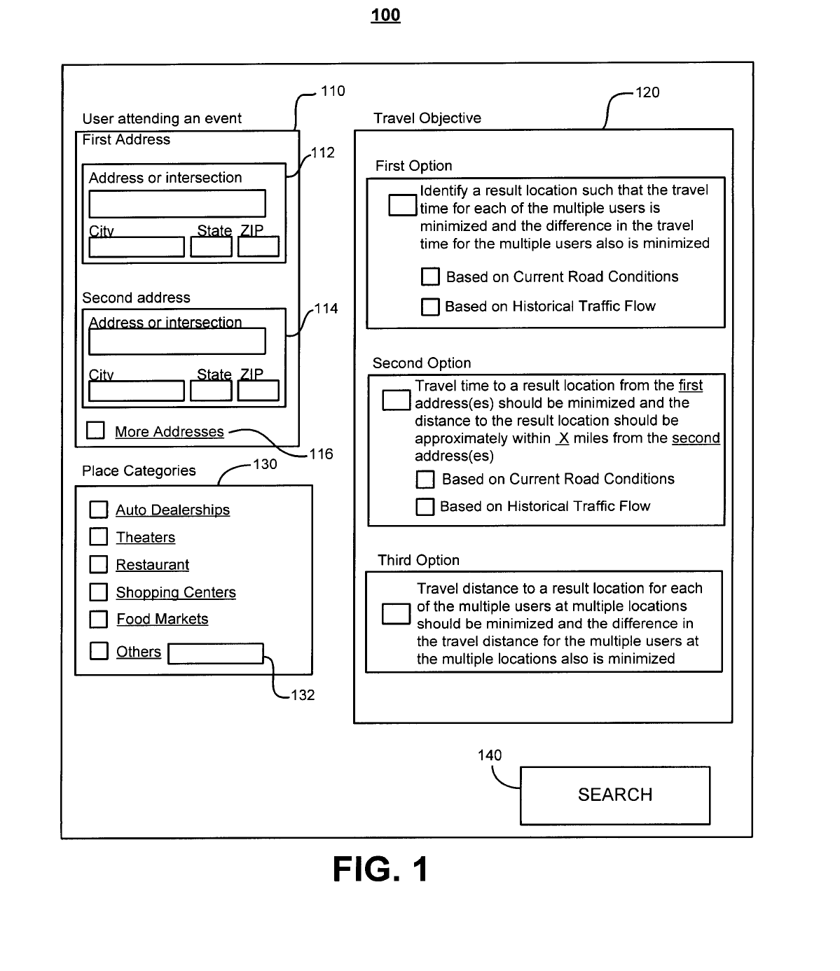

The user also submits a travel objective to the host. The travel objective may be selected by the user from among several options that are selected for display. The travel objective relates to the location data for the multiple users. The travel objective instructs the host to identify a particular place (e.g., a restaurant or a movie theater) that is conveniently located for the multiple users at the multiple locations, such that the travel commitment for each of the multiple users is minimized and the difference in the travel commitment for the multiple users also is minimized. The host uses the search query with the travel objective to perform a search. If the host identifies a result that is responsive to the search query and the travel objective, the host communicates the result to the client device, which in turn displays the result to its user. If several results are identified, they are presented in accordance with their relative satisfaction of the travel objective. For example, the host may prioritize the results, such that the results having the shortest travel commitment for each of the multiple users may be presented to the user first and the result with the longest travel commitment may be presented last. Alternatively or additionally, the host may communicate the result to each of the multiple users and generate directions to the result location for each of the multiple users based on their location data. FIG. 1 illustrates an exemplary user interface 100 that may be presented to the user wishing to obtain a result responsive to a search query and a travel objective. The user interface 100 may be used for manually entering location data for multiple users at multiple locations as a part of the search query. The user interface 100 includes a user selection portion 110, a travel objective selection portion 120, a place selection portion 130, and a search selection portion 140. The user selection portion 110 enables the user of the client device to specify the location data for the multiple users at the multiple locations. The user selection portion 110 includes a first address portion 112, a second address portion 114, and a “more addresses” icon 116. The first address portion 112 includes an address field, a city field, a state field, and a zip code field. Similarly, the second address portion 114 includes an address field, a city field, a state field, and a zip code field. The user may manually enter the location data for the multiple users in the first address portion 112 and the second address portion 114.

In one implementation, the user enters the user's present or future location in the first address portion 112 and enters another user's present or future location in the second address portion 114. Alternatively, the user may enter a present or a future location of other users in the first address portion 112 and/or the second address portion 114, or may combine entry of their address and the address of other user(s) into a single interface. The “more addresses” icon 116 enables the user to enter additional location data for additional users. For example, selecting the “more addresses” icon 116 may launch another user interface enabling the user to enter additional location data associated with additional users.

The travel objective selection portion 120 includes three user-selectable options that may be used as search criteria. A user-selectable option may specify a travel objective that relates to the location data for each of the multiple users. The first option effects identification of a result, such that travel time to a result location for each of the multiple users at the multiple locations is minimized, and a difference in the travel time to the result location for each of the multiple users also is minimized based on either or both of current road conditions and historical traffic flow. The current road conditions may include factors such as traffic, constructions, and/or accidents. The second option effects identification of a result, such that travel time to a result location for the first address is minimized and the result location is approximately within a user-specified distance from other locations (e.g., the second address). The third option effects identification of a result, such that a travel distance to a result location for each of the multiple users at the multiple locations is minimized, and a difference in the travel distance for the multiple users also is minimized.

The user interface 100 also includes the place selection portion 130. The place selection portion 130 presents place categories that the user may select. As shown, the place categories include auto dealerships, theaters, restaurants, shopping centers, food markets, and “other” categories, such as banks and ATMs. The place selection portion 130 may have associated sub-categories, such that when the user selects one of the place categories, the user is enabled to specify one or more criteria for use in identifying the place. In one example, if the user is searching for a particular restaurant, the user may select the restaurant category from the place selection portion 130. Selecting the restaurant category may launch another user interface that enables the user to specify one or more criteria associated with the restaurant category. The one or more criteria may include a price range, a type of cuisine, and/or restaurant's rating. If the user is searching for a particular place that is not shown, the user may specify the particular place in an “other” category field 132.

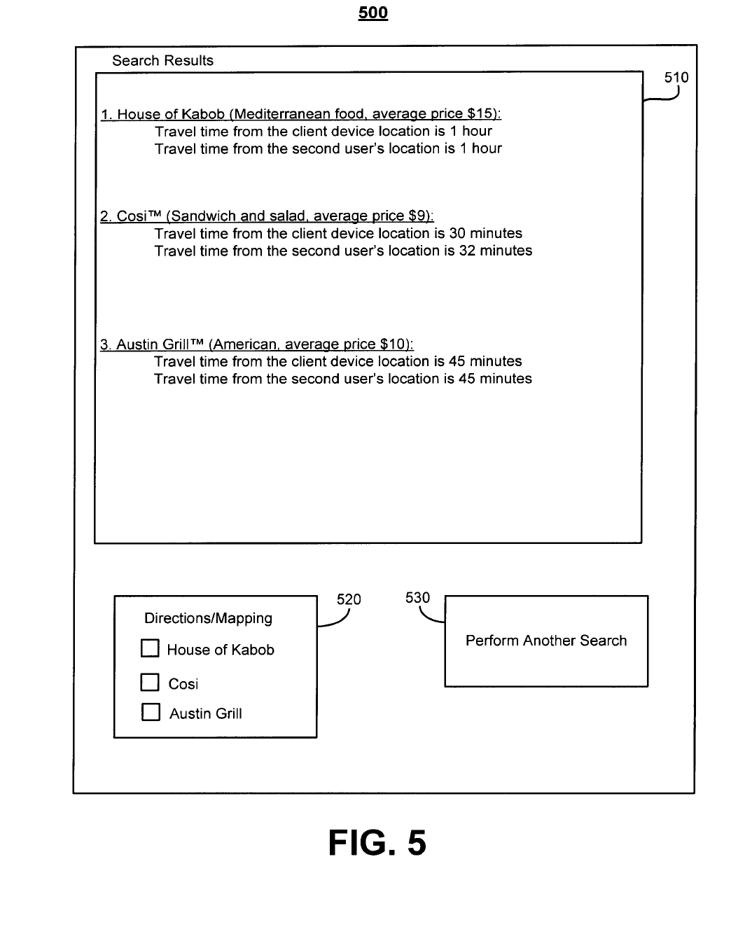

The user may activate the search selection portion 140 after specifying parameters in the user interface 100. In response to receiving the search query, the host searches and identifies a result. The host then enables the client device to access the result, for example, as shown in FIG. 5.

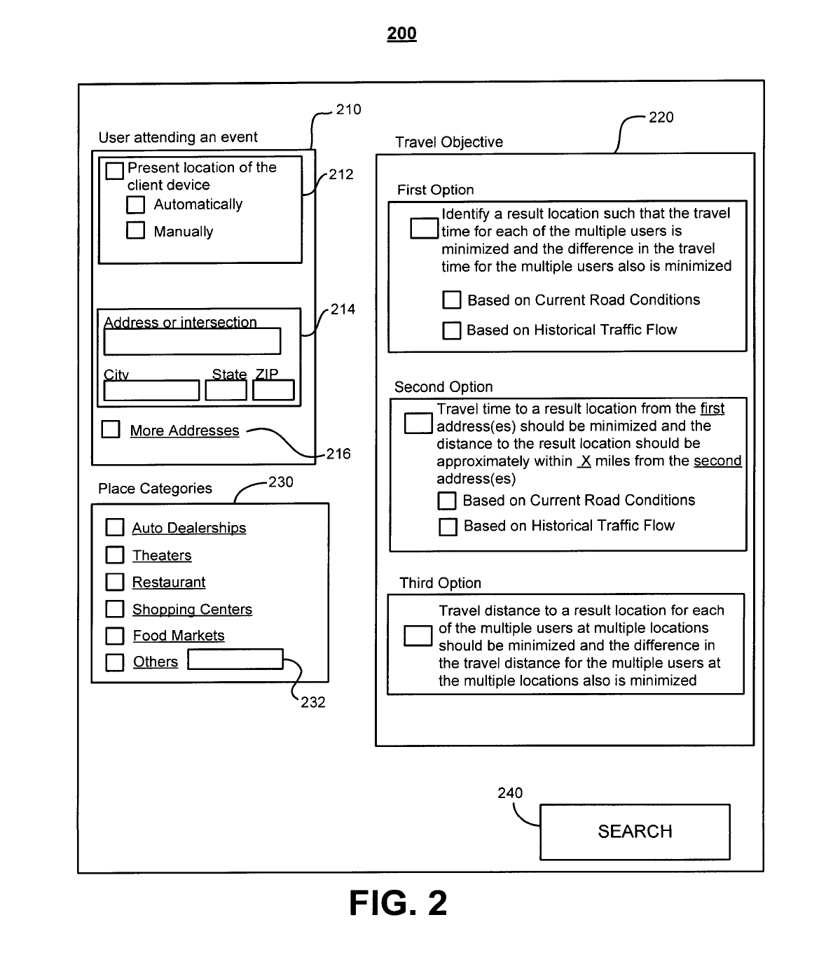

FIG. 2 illustrates an exemplary user interface 200 for identifying a result responsive to a search query and a travel objective using a present location of the client device that is automatically or manually provided to a host. The user interface 200 includes a user selection portion 210, a travel objective selection portion 220, a place selection portion 230, and a search selection portion 240. The user selection portion 210 includes a first address portion 212, a second address portion 214, and a “more addresses” icon 216.

The first address portion 212 enables the client device to communicate to the host the present location of the client device. The present location of the client device may be determined either automatically or manually. To determine the present location of the client device automatically, the host may utilize a satellite receiver, such as a global positioning system (“GPS”), an IP address, and/or a user's profile. In one implementation, the host automatically determines the present location of the client device based on the type of location-based technology implemented in the client device. If the client device is equipped with multiple location-based technologies enabling determination of the present location, then the host may use the technology that provides the most accurate information about the present location.

In one example, the client device may include a mobile device that is GPS-enabled, and the host may automatically glean the present location of the client device based on the GPS position of the client device. In another example, the present location of the client device may be automatically determined by registering the client device with a host (e.g., a Session Initiation Protocol (“SIP”)) server. The client device may provide information to the host that is used to derive location information. For example, the host may derive location information based on how the client device is accessing the network (e.g., as identified by source IP address or another packet identifier).

In yet another alternative, the present location of the client device may be automatically determined from the user's profile. For example, the user may have associated profile or contact information indicating a predetermined home and/or office location. In one specific example, the user of a client office computer may have previously stored the location of the user's office in the user's profile. Thus, the host may use the user's profile to determine the office location, which in turn may be used as part of the search query.

Alternatively, the present location of the client device may be determined manually. Selecting the manual option from the first address portion 212, launches another user interface enabling the user to enter information regarding the user's present location, which may be used as part of the search query.

Generally, the second address portion 214 and the “more addresses” icon 216 are similar to the second address portion 114 and the “more addresses” icon 116, respectively, as described above with respect to FIG. 1. Similarly, the travel objective selection portion 220, the place selection portion 230, and the search selection portion 240 are similar to the travel objective selection portion 120, the place selection portion 130, and the search selection portion 140, respectively, as described above with respect to FIG. 1.

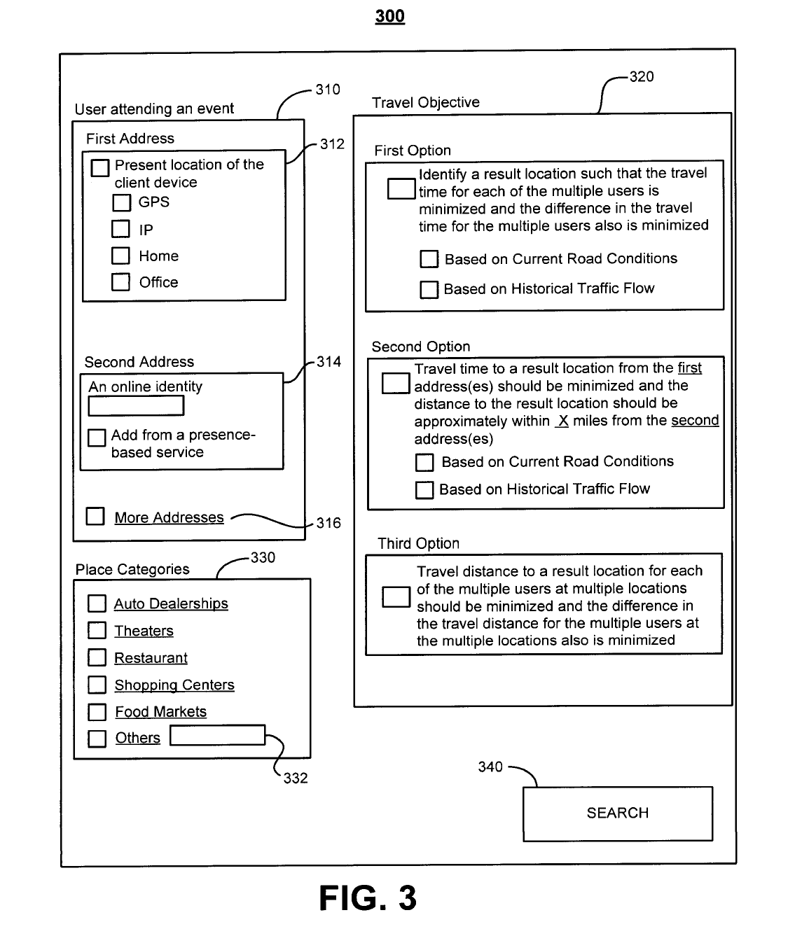

FIG. 3 illustrates an exemplary user interface 300 for identifying a result responsive to a search query and a travel objective using a location of a user that is provided to a host via an online identity and a present location of the client device that is automatically provided to the host. Similar to user interfaces 100 and 200 described above with respect to FIG. 1 and FIG. 2, the user interface 300 includes a user selection portion 310, a travel objective selection portion 320, a place selection portion 330, and a search selection portion 340. The user selection portion 310 includes a first address portion 312, a second address portion 314, and a “more addresses” icon 316. The first address portion 312 enables the client device to specify the location-based technology the host should use to derive the present location of the client device. For example, the client device may instruct the host to determine the present location via, for example, the GPS by selecting the GPS option in the first address portion 312. Alternatively, the client device may instruct the host to determine the present location via, for example, the client device's IP address and/or the user's profile as describe above with respect to FIG. 2.

The second address portion 314 includes an online identity field used to specify an online identity, which in turn may be used to determine location information for the user associated with the online identity. The second address portion 314 enables the user to specify an online identity, such as a screen name registered with a presence-based service. For example, the second address portion 314 may enable the user to provide a screen name from an instant messaging (“IM”) service. The IM service may be operated by the host or may be an independent IM service. In one implementation, the user manually enters the online identity. Alternatively, the user of the client device may add the online identity from an IM service (e.g., a list of co-users such as AOL's Buddy List™) by selecting the appropriate indicator in the second address portion 314. Once the online identity in the online identity field is specified, the location of the user associated with the online identity may be determined. In one implementation, the host may determine the location of the user associated with the online identity based on location information provided by the IM service. For example, the user associated with the online identity may choose to have his or her current location displayed with his or her screen name to some users on the IM service. Alternatively, the location information of the user may be determined via GPS or may be manually entered by the user into the IM service. In yet another implementation, the location information may be determined by accessing a profile with a location entry for the online identity. For example, the user associated with the online identity may specify the user's status as at “home” and/or at “office.” Accordingly, the host may be enabled to access the location entry for the online identity in the user's profile and determine the “home” or the “office” address.

Generally, the travel objective selection portion 320, the place selection portion 330, and the search selection portion 340 are similar to the travel objective selection portion 120, the place selection portion 130, and the search selection portion 140, respectively, as described above with respect to FIG. 1.

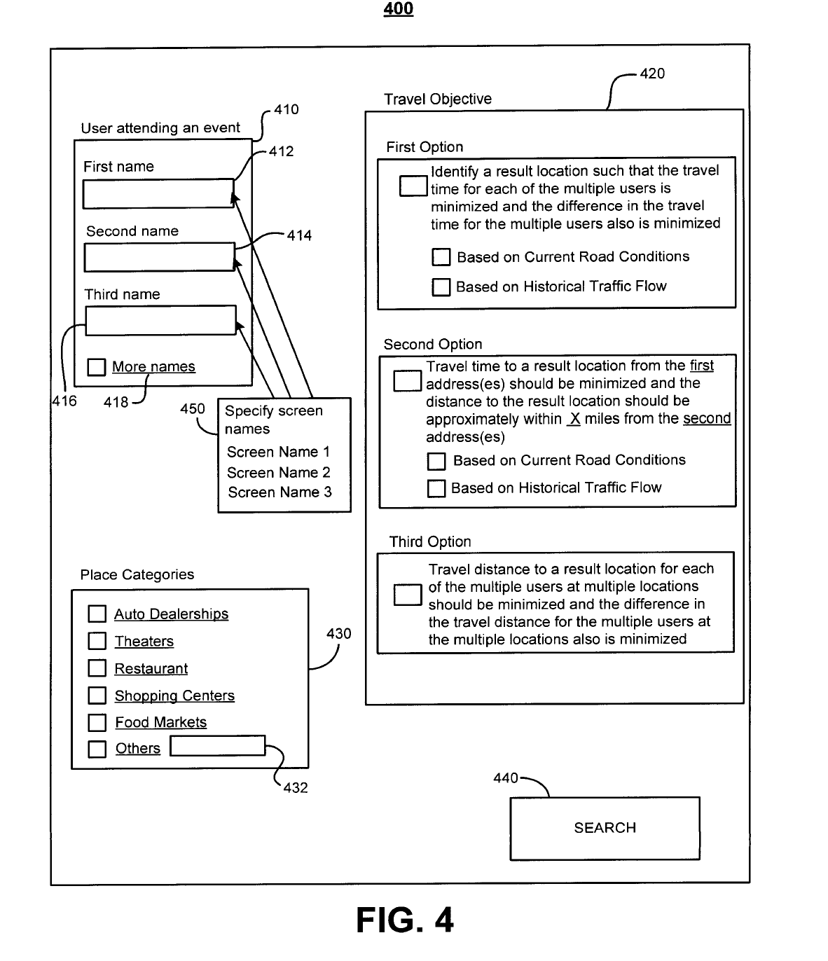

FIG. 4 illustrates an exemplary user interface 400 for identifying a result responsive to a search query and a travel objective using user names and/or screen names selected from a list of co-users. The user names and/or the screen names may be used to determine location data for multiple users at multiple locations. The user interface 400 includes a user selection portion 410 and an IM selection portion 450. The user selection portion 410 includes a first name field 412, a second name field 414, a third name field 416, and a “more names” icon 418. The IM selection portion 450 includes screen name 1, screen name 2, and screen name 3. The IM selection portion 450 may include an IM service mini-browser that includes a list of co-users for displaying other online identities (e.g., screen name 1, screen name 2, and screen name 3 in a Buddy List™). In one implementation, the name fields 412, 414, and 416 may be used to identify names of the users, which in turn may be used to determine locations of the users associated with the identified names as the search query is being configured. The location information associated with the users may be determined from the user's profile.

In another implementation, the user may import the screen names into the name fields 412, 414, and 416 from the IM selection portion 450. The location information associated with the screen names may be determined and communicated to the host based on one of the methods described above with respect to FIG. 3.

The user interface 400 also includes a travel objective selection portion 420, a place selection portion 430, and a search selection portion 440. Generally, the travel objective selection portion 420, the place selection portion 430, and the search selection portion 440 are similar to the travel objective selection portion 120, the place selection portion 130, and the search selection portion 140, as described above with respect to FIG. 1.

FIG. 5 illustrates an exemplary user interface 500 displaying results that are responsive to the search query and the travel objective, such as results responsive to the information submitted in user interfaces 100, 200, 300, or 400 described previously with respect to FIGS. 1-4. The user interface 500 includes a result selection portion 510, a directions/mapping selection portion 520, and a search selection portion 530. In one example, the result selection portion 510 includes results for restaurants that are located at approximately equal travel time from the current location of the client device and the location of a second user. The directions/mapping selection portion 520 enables the user to instruct the host to provide directions and/or mapping to one or more results locations. For example, if the user wishes to receive directions and/or mapping to the House of Kabob, the user may select the House of Kabob option in the directions/mapping selection portion 520. In response, the host provides the user with directions and/or mapping to the House of Kabob. Alternatively, the directions/mapping selection portion 520 may be included in the result selection portion 510, such that each of the identified results also includes the directions/mapping selection portion 520. The search selection portion 530 enables the user to perform another search.

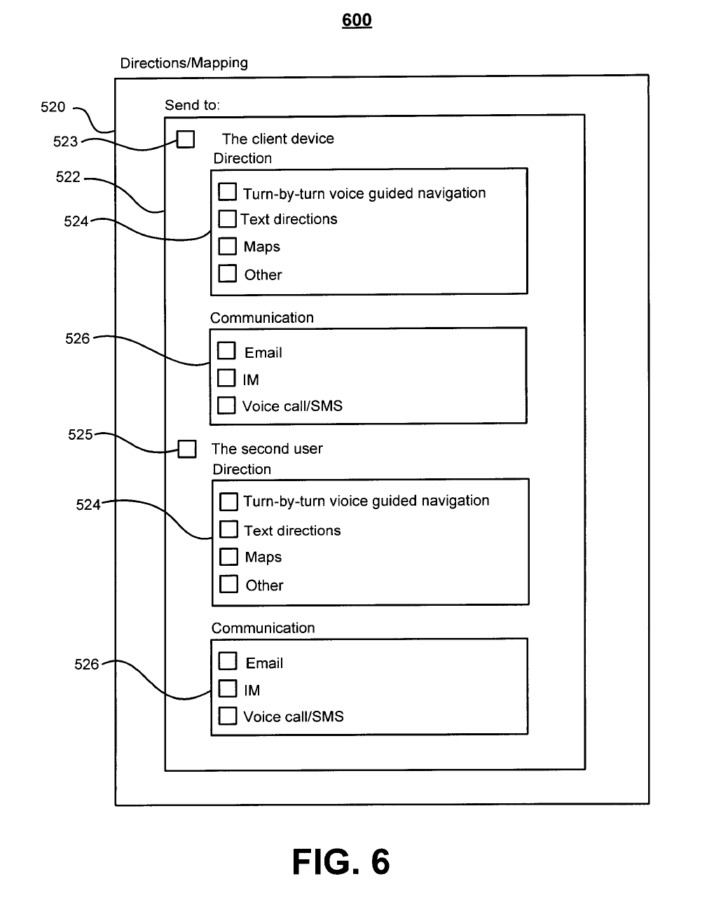

FIG. 6 illustrates an exemplary user interface 600 that may be used to specify how directions should be provided, for example, in response to selecting directions/mapping selection portion 520 shown in FIG. 5. The directions/mapping selection portion 520 includes a send-to-selection portion 522. The send-to-selection portion 522 enables the user to send directions to other users specified in the search query. For example, and referring again to FIG. 1, if the user wishes to send directions to the client device and a second user, the user may select the client device indicator 523 and the second user indicator 525.

The send-to-selection portion 522 also includes a direction field 524 and a communication field 526 for the specified users (e.g., the user of the client device and the second user). The direction field 524 enables specification of different types of directions. For example, the direction field 524 may be used to specify turn-by-turn voice guided navigation, text directions, mapping directions, and “other” types of directions, such as walking directions and/or public transportation directions. The communication field 526 enables the user to specify the manner in which the directions should be sent. For example, the communication field 526 enables the user to send the directions via email, instant messenger, short message service (“SMS”), or directly to the other client device's mobile/navigation application.

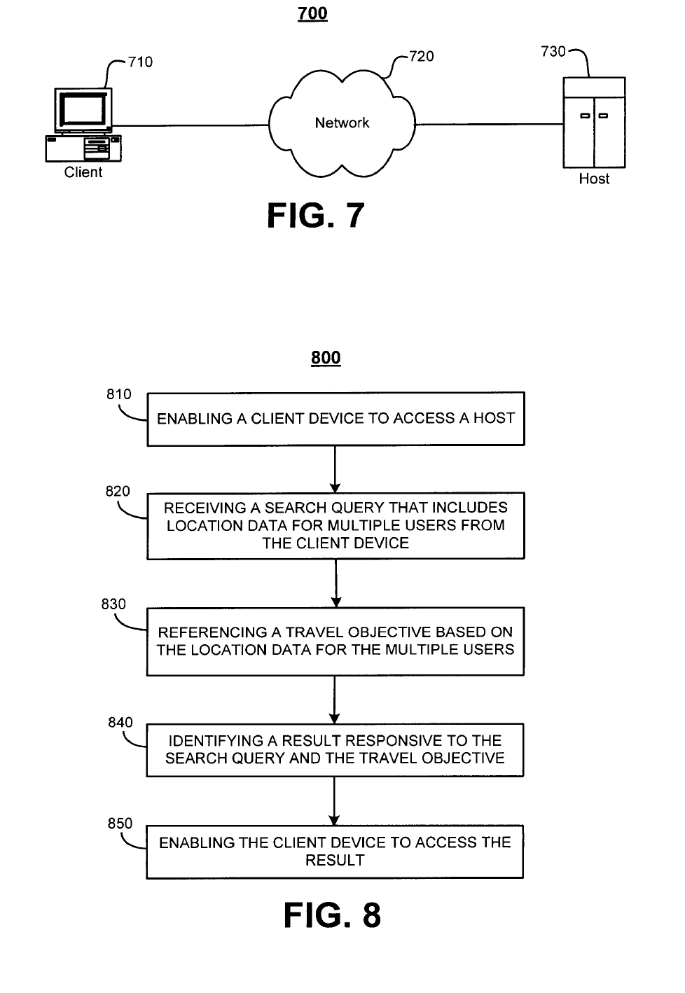

Referring to FIG. 7, a communication system 700 is capable of delivering and exchanging data between a client device 710 and a host 730 through a delivery network 720. The communication system 700 enables the client device 710 to provide a search query to the host 730 and receive a result in response.

Each of the client device 710 and the host 730 may be implemented by, for example, a general-purpose computer capable of responding to and executing instructions in a defined manner, a personal computer, a special-purpose computer, a workstation, a server, a device, a component, other equipment or some combination thereof capable of responding to and executing instructions. The client device 710 may be configured to receive instructions from, for example, a software application, a program, a piece of code, a device, a computer, a computer system, or a combination thereof, which independently or collectively direct operations, as described herein. The instructions may be embodied permanently or temporarily in any type of machine, component, equipment, storage medium, or propagated signal that is capable of being delivered to the client device 710 or the host 730.

The client device 710 may include one or more devices capable of accessing content on the host 730. The client device 710 may include a general-purpose computer (e.g., a personal computer (“PC”)) capable of responding to and executing instructions in a defined manner, a workstation, a notebook computer, a Personal Digital Assistant (“PDA”), a wireless phone, a component, other equipment, or some combination of these items that is capable of responding to and executing instructions.

In one implementation, the client device 710 includes one or more information retrieval software applications (e.g., a browser, a mail application, an instant messaging client, an Internet service provider client, a media player, a mobile location based services client, a mobile mapping and/or navigation client, or AOL video or other integrated client) capable of receiving one or more data units. The information retrieval applications run on a general-purpose operating system and a hardware platform that includes a general-purpose processor and specialized hardware for graphics, communications and/or other capabilities. In another implementation, the client device 710 includes a wireless telephone running a micro-browser application on a reduced operating system with general purpose and specialized hardware capable of operating in mobile environments.

In this implementation, the client device 710 is configured to input a search query that includes location data for multiple users and a travel objective based on the location data for the multiple users. The client device 710 also is configured to render a result responsive to the search query and the travel objective. For example, the client device 710 may be configured to generate a map, information regarding travel time and distance, and/or directions to the result.

The network 720 includes hardware and/or software capable of enabling direct or indirect communications between the client device 710 and the host 730. As such, the network 720 includes a direct link between the client device 710 and the host 730, or it includes one or more networks or subnetworks between them (not shown). Each network or subnetwork includes, for example, a wired or wireless data pathway capable of carrying and receiving data. Examples of the delivery network include the Internet, the World Wide Web, a WAN (“Wide Area Network”), a LAN (“Local Area Network”), analog or digital wired and wireless telephone networks, radio, television, cable, satellite, and/or any other delivery mechanism for carrying data.

The host 730 includes a general-purpose computer having a central processor unit (CPU), and memory/storage devices that store data and various programs such as an operating system and one or more application programs. Other examples of the host 730 include a workstation, a server, a special purpose device or component, a broadcast system, other equipment, or some combination thereof capable of responding to and executing instructions in a defined manner.

The host 730 includes a host operated by an Online Service Provider that provides searching services to subscribers. Alternatively or additionally, the host 730 includes a search provider. Alternatively or additionally, the host 730 includes a mobile device, such as a cellular-phone or an in-vehicle navigation system. The host 730 is configured to receive a search query and a travel objective. The search query may include location data associated with multiple users at multiple locations. The host 730 is therefore configured to provide a result that is responsive to the search query and the travel objective. Moreover, the host 730 may be configured to reference the travel objective to identify a result, such that a travel time commitment to a result location for each of the multiple users is minimized and differences in the travel commitments for the multiple users also is minimized. In another implementation, the host 730 is configured to reference the travel objective to identify a result, such that total travel commitment to a result location for the multiple users at the multiple locations is minimized. In yet another implementation, the host 730 is configured to find a result location, such that the travel time to the result location for a first of the multiple users is minimized, and the result location is within a user-specified distance from a second of the multiple users.

The host 730 may be configured to provide mapping services to the users. In one example, the host 730 is configured to generate maps, information regarding travel time, and/or distance to the result. The host 730 may be configured to enable selection of different types of directions. For example, the host 730 may be configured to enable turn-by-turn voice guided navigation, mapping directions, text directions, and/or “other” types of directions, such as walking direction or public transportation directions. The host 730 may be configured to send this information to the users via an instant messenger service, an email, SMS, or directly to a client mobile/navigation application.

In one implementation, the client device 710 alone may perform the functions described above. For example, the client device 710 may perform the functions described above by referencing an internal search engine. In another implementation, the host 730 alone may perform the functions described above. In yet another implementation, the client device 710 and the host 730 both may perform some or all of the functions described above.

Referring also to FIG. 8, a flow chart 800 illustrates an exemplary process by which a client device may interact with a host to identify a result responsive to a search query and a travel objective. Initially, the host receives, from the client device, the search query that enables access to location data for multiple users (810). Receiving the search query includes receiving the travel objective and an indication of a particular place (820). The particular place may include a point of interest where the multiple users wish to meet each other. For example, the particular place may include a restaurant, a movie theater, a shopping center or other locations, such as a bank or an ATM.

Enabling access to the location data for the multiple users may include receiving as a part of the search query a first location related to a first of the multiple users at the client device and a second location related to a second of the multiple users at a device other than the client device. Alternatively, enabling access to the location data for the multiple users may include receiving as a part of the search query a first location for a first of the multiple users at the client device and receiving an instruction to obtain a second location related to a second of the multiple users at a device other than the client device. The instruction to obtain the second location may include instructing the host to contact a server to obtain the second location.

The host accesses the location data for each of the multiple users (830) by receiving a message from the client device that itself reveals the location data as noted above. Alternatively, the host may contact the server to obtain the location data for some or all the multiple users. For example, the host may contact the server operated by a telephone service provider (e.g., Verizon or Sprint) with which the multiple users are registered, and obtain from the server the location data for the multiple users.

The host references the travel objective that relates to the location data for each of the multiple users (840). Referencing the travel objective may include identifying a result location such that a travel commitment for each of the multiple users is minimized and differences in the travel commitment for each of the multiple users also is minimized. Alternatively, referencing the travel objective may include minimizing total travel commitment among the multiple users. The travel commitment may include a travel distance and/or travel time. In yet another implementation, referencing the travel objective may include identifying a result location, such that travel time to a result location for the first of the multiple users is minimized and the result location is approximately within a user-specified distance from the second of the multiple users.

In one example, the total travel commitment to the result location may be equal to or less than the travel commitment for any of the multiple users. To illustrate, the user may specify a travel objective that includes identifying a restaurant, such that the total travel distance to the restaurant for the multiple users is minimized. The host may identify a restaurant responsive to the travel objective, such that the restaurant is one mile from a first of the multiple users and five miles from a second of the multiple users. As such, the total travel distance is six miles. Alternatively, the user may specify a travel objective that includes identifying a restaurant that is approximately equidistant from the multiple users. In response, the host may identify a restaurant that is seven miles from each of the multiple users. As illustrated, the travel distance for each of the multiple users in this case is greater than the total travel distance in the previous scenario.

The host identifies a result associated with the particular place and responsive to the search query and the travel objective (850). Identifying the result responsive to the search query and the travel objective may include identifying one or more results that are responsive to the user-specified parameters previously provided to the host via the user interface 100, 200, 300, or 400 shown in FIGS. 1-4. After identifying the result, the host enables the client device to access the result (850). Enabling the client device to access the result may include providing the result to the user and providing directions to a result location for the multiple users at the multiple locations. As part of providing directions to the result location, the client device may be enabled to select among different types of directions. For example, the client device may be enabled to select turn-by-turn voice guided navigation, mapping directions, text directions, and “other” types of directions, such as walking directions and/or public transportation directions. Upon specifying the type of directions for the multiple users, the user may be enabled to specify the manner in which the directions should be sent. For example, the user may be enabled to send the directions via email, instant messenger, SMS, voice call, and/or directly to another client application.

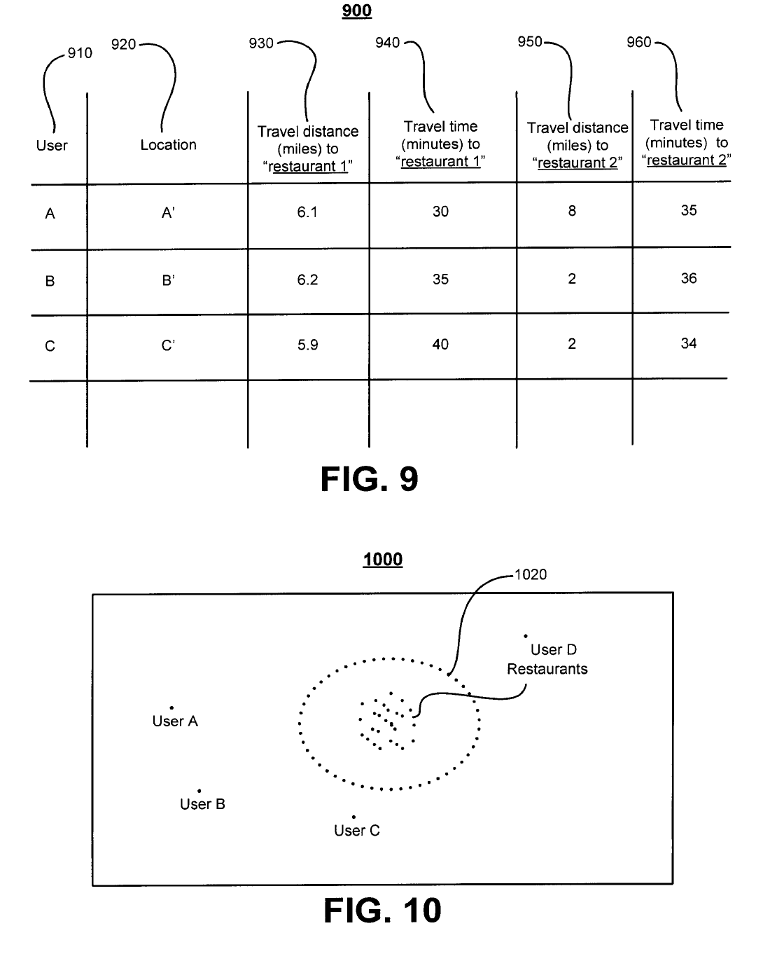

FIGS. 9 and 10 illustrate exemplary techniques that may be used to identify a result that is responsive to a search query and a travel objective. Referring to FIG. 9, the host may first identify results that meet the user's criteria as specified in the search query. Subsequently, the host may determine which of the results are convenient for the multiple users based on the travel objective. FIG. 9 illustrates an organization for database 900 enabling the host to determine which of the results are responsive to the travel objective. The database 900 may include a user column 910, a location column 920, distance columns 930 and 950, and travel time columns 940 and 960. The user column 910 may include user names A, B, and C. The location column 920 may include geographical locations associated with the users A, B, and C. For example, the location column 920 may include location A′ associated with the user A, location B′ associated with the user B, and location C′ associated with the user C. The locations A′, B′, and C′ may be used to determine travel time and/or a travel distance to a result location (e.g., a restaurant location as shown in FIG. 9).

The distance column 930 may specify a distance from the locations A′, B′, and C′ to a first restaurant. In one example, the distance from the locations A′, B′, and C′ to the first restaurant is approximately the same (e.g., 6 miles). The travel time column 940 may specify the travel time from the locations A′, B′, and C′ to the first restaurant based on current road conditions and/or historical traffic flow. For example, as shown in FIG. 9, the travel time from the location A′ to the first location is 30 minutes, the travel time from the location B′ to the first restaurant is 35 minutes, and the travel time from the location C′ to the first restaurant is 40 minutes. In one implementation, to determine the travel time, the host first determines a modality of travel for each of the multiple users and calculates the travel time based on the modality of travel for each of the multiple users. For example, the host may receive an instruction specifying a modality of travel for the first of the multiple users and the second of the multiple users and may provide directions and travel time according to the modality of travel for each of the multiple users. The host may receive the instruction from the first of the multiple users at the client device. Alternatively, the host may receive a first set of instructions from the first of the multiple users at the client device, specifying the modality of travel of the first user and receive a second set of instruction, from the second of the multiple users at a device other than the client device, specifying the modality of travel of the second user.

The distance column 950 may indicate a travel distance from the locations A′, B′, and C′ to a second restaurant. For example, as shown in FIG. 9, the distance from the location A′ to the second restaurant is 8 miles, and the distance from the locations B′ and C′ to the second restaurant is 2 miles. The travel time column 960 may indicate travel time to the second restaurant based on the current road conditions and/or the historical traffic flow. In one example, as shown in FIG. 9, the travel time from the locations A′, B′, and C′ to the second restaurant may be approximately the same (e.g., 35 minutes). The travel time from the location A′ to the second restaurant is 35 minutes, the travel time from the location B′ to the second restaurant is 36 minutes, and the travel time from the location C′ to the restaurant is 34 minutes.

To determine which of the restaurants (e.g., the first restaurant or the second restaurant) is more responsive to the travel objective, the host may use the information in the distance columns 930 and 950 and the travel time columns 940 and 960. If the travel objective includes identifying a restaurant, such that the travel distance for each of the multiple users A, B, and C is minimized, and the differences in the travel distance for each of the multiple users also is minimized, the host may return a result associated with the first restaurant. In contrast, if the travel objective includes identifying a restaurant, such that the travel time for each of the multiple users A, B, and C is minimized, and the differences in the travel time for each of the multiple users A, B, and C also is minimized, the host may return a result associated with the second restaurant. Similarly, if the travel objective includes identifying a restaurant location, such that a total travel distance from the locations A′, B′, and C′ is minimized, the host may return a result associated with the second restaurant.

Alternatively, the database 900 may be presented to a user as the user interface, such that the user is enabled to manually select the result that is responsive to the search query and the travel objective. For example, the user may be enabled to manually select the first restaurant or the second restaurant by “clicking on” the “restaurant 1” or “restaurant 2,” respectively.

FIG. 10 illustrates an exemplary technique for identifying a result location that is responsive to the travel objective by searching within a boundary that satisfies the travel objective. FIG. 10 illustrates a map 1000 that includes location information for multiple users and a boundary 1020. The multiple users may include users A, B, C, and D and their locations, as shown in FIG. 10, may be spread out in the map 1000. Based on the travel objective specified by the user via the user interface 100, 200, 300, or 400 shown in FIGS. 1-4, the host may determine that the area represented by the boundary 1020 is responsive to the travel objective. The host then may search within the boundary 1020 for a result location.

In one example, the result may include a restaurant. The travel objective may include identifying a restaurant location, such that travel time to the restaurant location for each of the users A, B, C, and D is minimized and the differences in travel time also is minimized. The host determines that restaurants in the boundary 1020 have approximately the same travel time for the users A, B, C, and D. The host may then search within the boundary 1020 to identify a restaurant location that is responsive to the user's search query (e.g., cuisine style, price, or other criteria). The host may then communicate the identified results to the client device or to each of the multiple users for selection. For example, the host may communicate the result via, for example, email, instant messenger, SMS, and voice call. Alternatively, the map 1000 may be presented to the user as a user interface, such that the user is enabled to manually select one or more identified results that are responsive to the search query and the travel objective. For example, the user may be enabled to select the result by clicking on the identified result location on the map.

Other implementations are within the scope of the following claims. For example, a user interface may be configured to enable the user to vary the level of detail for the location data used as part of the search query. The user may choose to provide specific location data for the multiple users (e.g., address, city, state, and/or zip code). Alternatively, if the user knows the zip code for one of the multiple users, the user may provide the host with the zip code information, and the host may perform a search based on the zip code.

Other techniques, such as wireless network correlation techniques, TV tower, cell tower, and/or radio frequency signal patterns of a client device may be used to automatically determine the current location of the client device. For example, the current location may be determined via a base station or an access point that the client device is using to communicate with others. The location of the base station or the access point indicates the proximate current location of the client device.

Referring again to FIG. 10, it is possible that the restaurants within the boundary 1020 may not be responsive to the search query. In this situation, the host may begin searching outside the boundary 1020 to identify the particular restaurant. The host may first begin searching within the close proximity of the boundary 1020 and then expand its search outwardly until the host identifies the particular restaurant.

In another implementation, a user interface may be configured to include an “automatic mode” option, a “manual mode” option, a user selection portion, a place selection portion, and a search selection portion. The selection of the “automatic mode” option enables the user to automatically provide the host with the user's present location and a default travel objective. More particularly, in the “automatic mode” option, the user's present location is automatically provided to the host based on one or more location-based techniques, such as GPS and/or IP address, without requiring the user to select options from, for example, the first address portion 312 shown in FIG. 3. Similarly, in the “automatic mode” option, the default travel objective is automatically provided to the host without requiring the user to select options from, for example, the travel objective selection portion 320 shown in FIG. 3. In one implementation, the default travel objective includes identifying a result, such that travel time to a result location for each of the multiple users is minimized, and the differences in the travel time to the result location for the multiple users also is minimized based on the current road conditions and/or the historical road conditions. In another implementation, the default travel objective includes identifying a result, such that a travel distance to a result location for each of the multiple users is minimized, and the differences in the travel distance to the result location for the multiple users also is minimized.

The user interface also is configured to include the “manual mode” option. The selection of the “manual mode” option enables the user to override the “automatic mode” option, enabling the user to provide the user's present location manually or via, for example, selecting the options in the first address portion 312 shown in FIG. 3. The “manual mode” option also enables the user to manually specify the travel objective as described above, for example, with respect to FIG. 3.

The user interface also includes the user selection portion, the place selection portion, and the search selection portion. The user selection portion is used to identify locations of other users. The user selection portion includes a second address portion and a more addresses icon similar to, for example, the second address portion 314 and the more address icon 316 shown in FIG. 3 to enable to user to provide location data for additional users. The place selection portion and the search selection portion are similar to, for example, the place selection portion 330 and the search selection portion 340 described above with respect to FIG. 3.

Although some operations described as being performed by a host, a client device and/or combinations of the client device and a host also may perform these operations. Other implementations are within the scope of the following claims.

What is claimed is:

1. A method comprising:
receiving, at a host from a client device, a search query that enables access to location data associated with multiple users, wherein receiving the search query includes:
receiving a travel objective, and
receiving an indication of a particular place;
accessing the location data associated with the multiple users;
referencing the travel objective that relates to the location data associated with the multiple users;
identifying a result associated with the particular place, wherein the result is responsive to the search query and the travel objective; and
enabling the client device to access the result.

2. The method of claim 1 wherein referencing the travel objective includes determining that differences in a travel commitment for the multiple users at multiple locations should be minimized.

3. The method of claim 2 wherein the travel commitment includes travel time or a travel distance.

4. The method of claim 1 wherein receiving the search query includes:
receiving a first location related to a first of the multiple users, wherein the first location includes a present location of the client device; and
receiving a second location related to a second of the multiple users, wherein the second location includes a location for a device other than the client device.

5. The method of claim 1 wherein identifying the result includes:
accessing current road conditions information; and
identifying the result based on the current road conditions information.

6. The method of claim 1 further comprising:
sending a first set of directions to a result location to a first user at the client device; and
sending a second set of directions to the result location to a second user at a device other than the client device.

7. The method of claim 6 wherein the directions includes turn-by-turn voice guided navigations, text directions, mapping directions, walking directions, or public transportation directions.

8. The method of claim 6 wherein sending the first set of directions includes:
accessing a first location related to the first user; and
generating the directions to the result location from the first location.

9. The method of claim 6 wherein sending the second set of directions includes:
accessing a second location related to the second user; and
generating the directions to the result location from the second location.

10. The method of claim 1 wherein receiving the search query includes:
receiving a first location related to a first user;
receiving a second location related to a second user; and
receiving the travel objective for minimizing differences in a travel commitment for the first user and the second user.

11. The method of claim 10 wherein receiving the search query includes
receiving an instruction specifying a modality of travel of the first user and the second user; and
providing directions to a result location for the first user and the second user based on the modality of travel of the first user and the second user.

12. The method of claim 1 wherein enabling the client device to access the result includes:
displaying one or more results to a first user at the client device, wherein the one or more results are responsive to the search query and the travel objective;
receiving, from the first user, an instruction to provide the first user and a second user with directions to the one or more results; and
providing the directions to the one or more results according to the instruction.

13. The method of claim 1 further comprising receiving an instruction at the host specifying a type of directions that should be provided to a result location for a first user and a second user.

14. The method of claim 1 wherein referencing the travel objective includes minimizing the travel commitment associated with each of the multiple users at multiple locations and minimizing the differences in the travel commitment associated with each of the multiple users at the multiple locations.

15. The method of claim 14 wherein the travel commitment includes travel time or a travel distance.

16. A method comprising:
receiving, at a host from a client device, a search query that enables access to location data associated with each of multiple users, wherein receiving the search query includes:
receiving a travel objective, and
receiving an indication of a particular place;
accessing the location data associated with each of the multiple users;
referencing the travel objective that relates to the location data associated with each of the multiple users;
identifying at least one result associated with the particular place, wherein the at least one result is responsive to the search query and the travel objective;
displaying the at least one result to a user of the client device;
enabling the user to select the at least one result; and
providing directions to the at least one result upon the user selecting the at least one result.

17. The method of claim 16 wherein receiving the search query includes:
receiving a first location related to a first of the multiple users; and
receiving an instruction to obtain a second location related to a second of the multiple users.

18. The method of claim 17 wherein receiving the instruction to obtain the second location includes instructing the host to contact a server to obtain the second location.
